(19) United States
(12) Patent Application Publication
(10) Pub. No.: US 2013/0342097 A1
(43) Pub. Date: Dec. 26, 2013

(54) LIGHT EMITTING DIODE PACKAGE STRUCTURE

(71) Applicant: Synergy Optoelectronic (Shenzhen) Co., Ltd., Shenzhen (CN)

(72) Inventors: SIN-TUNG HUANG, Hsinchu (TW); WUN-CI KANG, Hsinchu (TW)

(21) Appl. No.: 13/922,285

(22) Filed: Jun. 20, 2013

(30) Foreign Application Priority Data
Jun. 20, 2012 (CN) 2012102048330

(51) Int. Cl. H05B 33/04

(52) U.S. Cl. CPC H05B 33/04
USPC 313/113

(57) ABSTRACT

An exemplary light emitting package includes a reflector, a receiving groove defined in the reflector, a light emitting device, and an encapsulation body. The light emitting device is received in the receiving groove and covered by the encapsulation body. The encapsulation body includes a number of light guide layers, and refractive indexes of the light guide layers gradually increase along a direction corresponding to a direction of propagation of the light from the light emitting device.

### BACKGROUND

1. Technical Field

The present disclosure relates to light emitting packages such as a light emitting diode package.

2. Description of Related Art

Generally, a light emitting element package such as a light emitting diode (LED) package uses one encapsulation body to cover an LED chip. Thus, light beams emitted from the LED chip transmit along respective straight lines in the encapsulation body. However, some of the light beams are reflected in the light emitting element package and at least partly absorbed by the encapsulation body. This reduces the illumination efficiency of the light emitting element package.

Therefore, it is desirable to provide a means which can overcome the above-mentioned shortcomings.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the views, and all the views are schematic.

FIG. 1 is a cross-sectional view of a light emitting package in accordance with a first exemplary embodiment, showing essential optical paths thereof.

FIG. 2 is a cross-sectional view of a light emitting package in accordance with a second exemplary embodiment, showing essential optical paths thereof.

FIG. 3 is a cross-sectional view of a light emitting package in accordance with a third exemplary embodiment, showing essential optical paths thereof.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

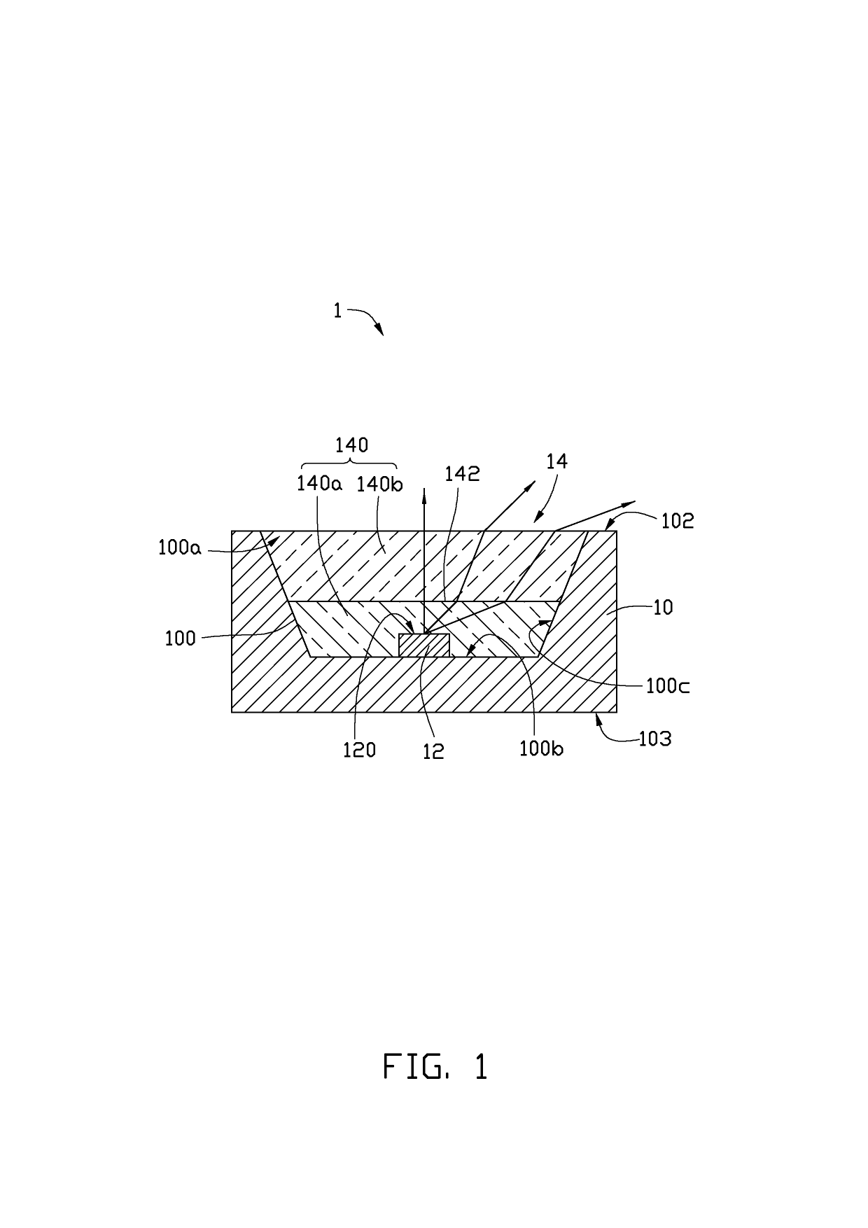

Referring to FIG. 1, a light emitting package 1 includes a reflector 10, a light emitting device 12, and a transparent encapsulation body 140. The reflector 10 defines a receiving groove 100. The light emitting device 12 is received in the receiving groove 100. The encapsulation body 140 is filled into the receiving groove 100 to cover the light emitting device 12. Light emitted from the light emitting device 12 passes through the encapsulation body 140, and is emitted out of the light emitting package 1 at a top end of the reflector 10 through an interface between an exiting surface of the encapsulation body 140 and the exterior of the light emitting package 1. In this embodiment, the light emitting device 12 is an LED chip. It is understood that, in other embodiments, the light emitting device 12 can be an organic light emitting diode (OLED) chip or a light bulb. Furthermore, in other embodiments, there may be more than one light emitting device 12.

The reflector 10 includes an upper surface 102, and a lower surface 103 parallel to the upper surface 102. The receiving groove 100 is defined in the upper surface 102. The receiving groove 100 defines an opening 100a, a bottom surface 100b below and substantially parallel with the opening 100a, and a sidewall 100c connecting the bottom surface 100b and the upper surface 102 at a periphery of the opening 100a. The area of the opening 100a is greater than the area of the bottom surface 100b.

The light emitting device 12 includes a light emitting surface 120. The light emitting device 12 is set on a center of the bottom surface 100b, with the light emitting surface 120 below and substantially parallel with the opening 100a. The encapsulation body 140 is filled into the receiving groove 100. The encapsulation body 140 includes a transparent main light guide layer 140a and at least one transparent secondary light guide layer 140b. In this embodiment, the encapsulation body 140 includes the main light guide layer 140a and a single secondary light guide layer 140b. The main light guide layer 140a is located at the bottom of the receiving groove 100 and directly covers the light emitting device 12. The secondary light guide layer 140b is stacked on the main light guide layer 140a. Refractive indexes of the two light guide layers 140a, 140b are different from each other. The main light guide layer 140a has a lower refractive index. The secondary light guide layer 140b has a greater refractive index. An interface 142 between the main light guide layer 140a and the secondary light guide layer 140b is a flat surface parallel to the lower surface 103 of the reflector 10. The exiting surface of the encapsulation body 140 is an exiting surface of the secondary light guide layer 140b.

In other embodiments, when there are two or more secondary light guide layers 140b, the secondary light guide layers 140b are stacked one on the other. The refractive indexes of all the light guide layers 140a, 140b are different from each other. The refractive indexes of the different light guide layers 140a, 140b gradually increase along a direction away from the bottom surface 100b.

Because of the difference in the refractive indexes between the two adjacent light guide layers 140a, 140b, when the light emitted from the light emitting device 12 crosses the interface 142 between two adjacent light guide layers 140a, 140b, the light is refracted toward a central axis of the receiving groove 100 that is perpendicular to the bottom surface 100b. In FIG. 1, the central axis coincides with a vertical light path shown extending directly up from the light emitting device 12. That is, upon refraction, paths of beams of the light converge to directions that are closer to being parallel with the central axis of the receiving groove 100. Therefore light beams aiming towards the sidewall 100c are redirected after being refracted toward the central axis of the receiving groove 100, and at least some of such light beams avoid being reflected by the sidewall 100c before they are emitted out of the exiting surface of the secondary light guide layer 140b at the opening 100a. Thus the light extraction efficiency of the light emitting package 1 can be significantly improved. Furthermore, the light beams emitted out of the exiting surface of the secondary light guide layer 140b are more converged to achieve output light closer to collimated light.

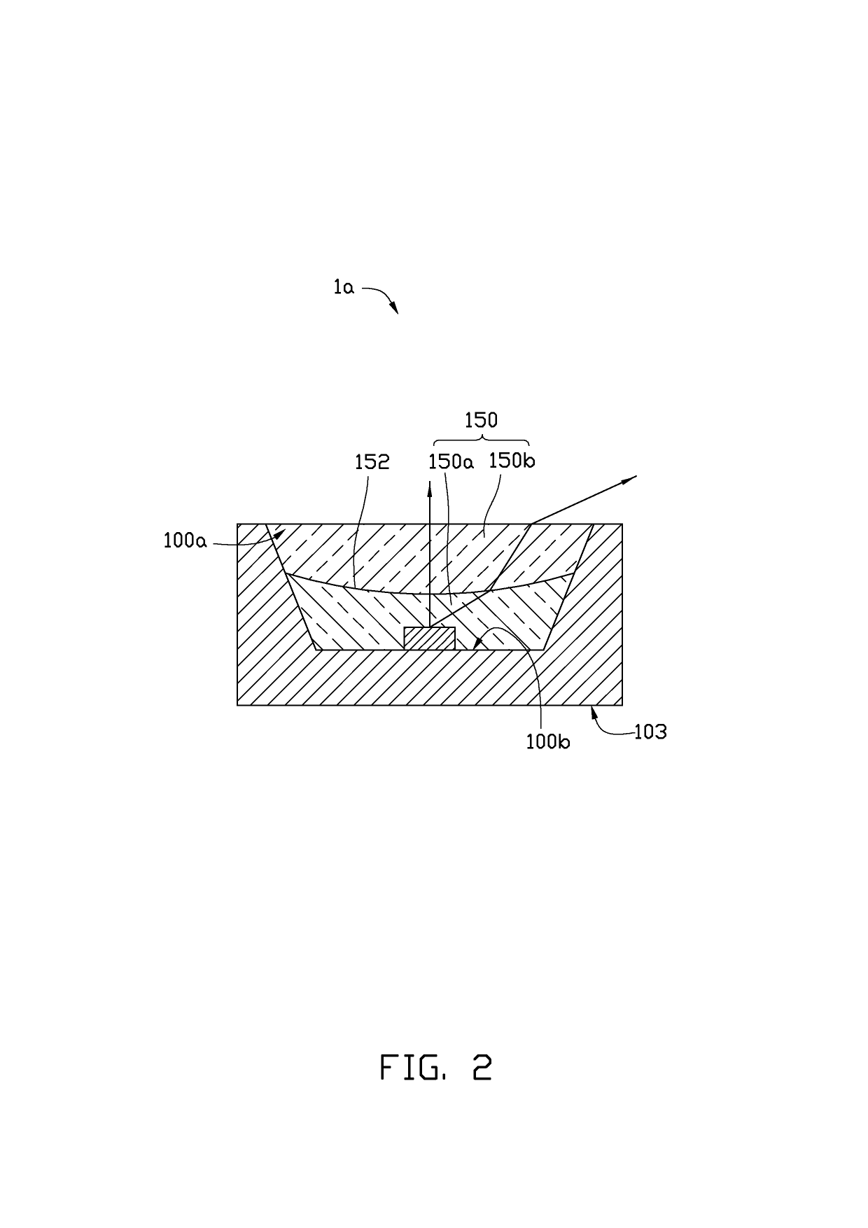

Referring to FIG. 2, a light emitting package la of a second embodiment is similar to the light emitting package 1 of the first embodiment. However, in the light emitting package la, an interface 152 between two adjacent light guide layers 150a, 150b of an encapsulation body 150 is a smooth curved surface. The smooth curved surface can be concave or convex with respect to the lower surface 103. The smooth curved surface provides varying degrees of convergence of the light beams emitted from the light emitting device 12.

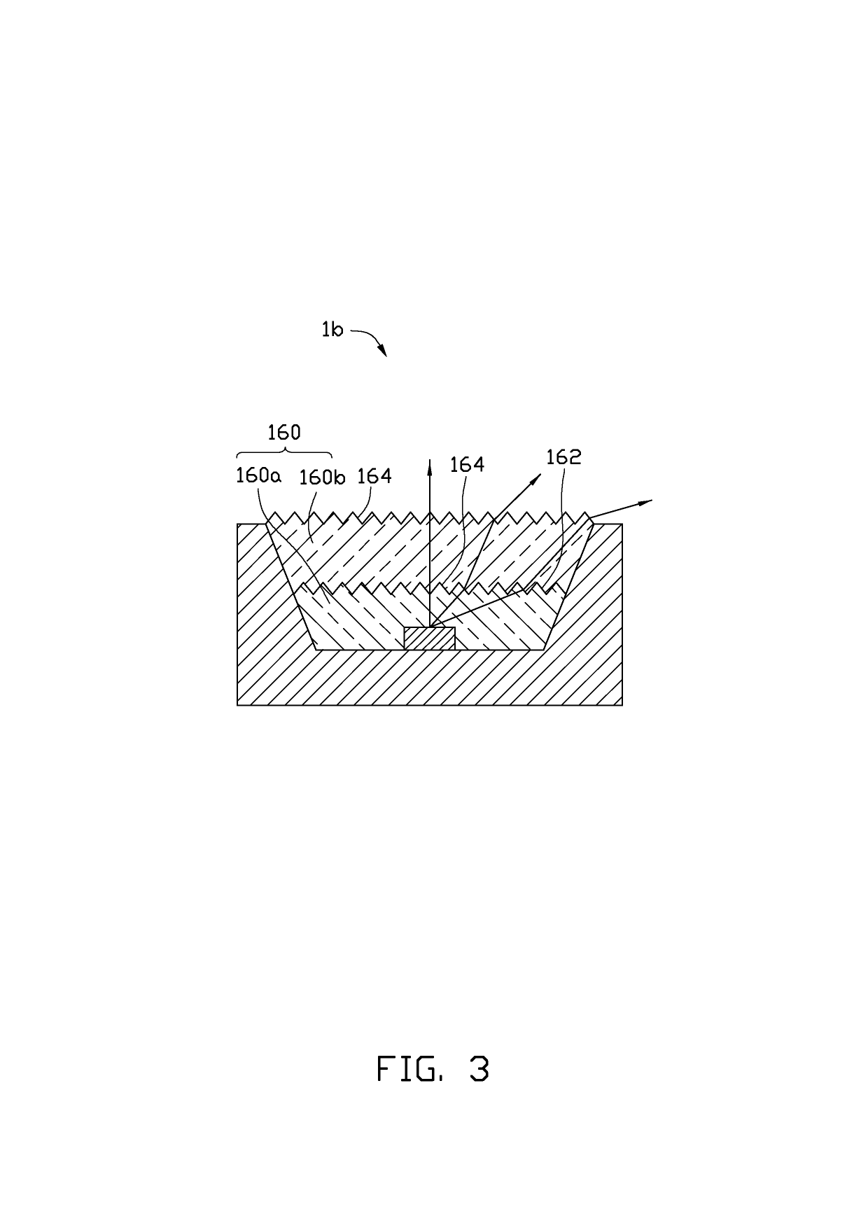

Referring to FIG. 3, a light emitting package lb of a third embodiment is similar to the light emitting package 1 of the first embodiment. However, in the light emitting package 1b, there are a number of microstructures 164 formed on an interface 162 between two adjacent light guide layers 160a, 160b of an encapsulation body 160. In addition, there are a number of microstructures 164 formed on an exiting surface of the secondary light guide layer 160b. In the illustrated embodiment, the microstructures 164 are a number of parallel V-shaped prism portions (which define V-cut grooves therebetween) each extending along a predetermined direction so as to define a sawtooth transverse cross-section. In other embodiments, the microstructures 164 can be a number of parallel semicylindrical protrusion portions each extending along a predetermined direction, a number of hemispherical bumps, a number of conic bumps, etc.

While various embodiments have been described, it is to be understood that the present disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A light emitting package comprising:
a reflector;
a receiving groove defined in the reflector;
a light emitting device set on a bottom of the receiving groove; and
a transparent encapsulation body filled in the receiving groove and covering the light emitting device, wherein the encapsulation body comprises a main light guide layer directly covering the light emitting device and at least one secondary light guide layer stacked on the main light guide layer, refractive indexes of the main light guide layer and the at least one secondary light guide layer are all different, and the refractive indexes of the main light guide layer and the at least one secondary light guide layer gradually increase along a direction away from the bottom surface.

2. The light emitting package of claim 1, wherein the reflector comprises an upper surface and a lower surface parallel to the upper surface, and the receiving groove is defined in the upper surface.

3. The light emitting package of claim 2, wherein an interface between each two adjacent light guide layers is a flat surface parallel to the lower surface of the reflector.

4. The light emitting package of claim 2, wherein the receiving groove defines an opening, a bottom surface below and substantially parallel with the opening, and a sidewall connecting the bottom surface and the upper surface at a periphery of the opening, and the area of the opening is greater than the area of the bottom surface.

5. The light emitting package of claim 1, wherein an interface between each two adjacent light guide layers is a smooth curved surface.

6. The light emitting package of claim 5, wherein the smooth curved surface protrudes toward the light emitting device.

7. The light emitting package of claim 5, wherein the smooth curved surface protrudes away from the light emitting device.

8. The light emitting package of claim 1, further comprising a plurality of microstructures provided on an interface between each two adjacent light guide layers.

9. The light emitting package of claim 8, wherein the microstructures are selected from the group consisting of a plurality of parallel V-shaped prisms each extending along a predetermined direction, a plurality of parallel semicylindrical protrusions each extending along a predetermined direction, a plurality of hemispherical bumps, and a plurality of conic bumps.

10. The light emitting package of claim 1, wherein the light emitting device is selected from the group consisting of a light emitting diode chip, an organic light emitting diode chip, and a light bulb.

11. A light emitting package comprising:
at least one light emitting device emitting light; and
a transparent encapsulation body covering the light emitting device, wherein the encapsulation body comprises a plurality of light guide layers, and refractive indexes of the light guide layers gradually increase along a direction corresponding to a direction of propagation of the light from the at least one light emitting device.

12. The light emitting package of claim 11, wherein the at least one light emitting device is selected from the group consisting of a light emitting diode chip, an organic light emitting diode chip, and a light bulb.

13. The light emitting package of claim 11, further comprising:
a reflector; and
a receiving groove defined in the reflector, wherein the light emitting device is received in the received groove.

14. The light emitting package of claim 13, wherein the reflector comprises an upper surface and a lower surface parallel to the upper surface, and the receiving groove is defined in the upper surface.

15. The light emitting package of claim 14, wherein the receiving groove defines an opening, a bottom surface below and substantially parallel with the opening, and a sidewall connecting the bottom surface and the upper surface at a periphery of the opening, and the area of the opening is greater than the area of the bottom surface.

16. A light emitting package comprising:
a reflector;
a receiving groove defined in the reflector;
a light emitting device set on a bottom of the receiving groove; and
a transparent main light guide layer filled in part of the receiving groove and directly covering the light emitting device; and
a transparent secondary light guide layer filled in another part of the receiving groove and stacked on the main light guide layer, wherein a refractive index of the secondary light guide layer is greater than a refractive index of the main light guide layer.

17. The light emitting package of claim 16, wherein the reflector comprises an upper surface and a lower surface parallel to the upper surface, and the receiving groove is defined in the upper surface.

18. The light emitting package of claim 17, wherein an interface between the main light guide layer and the secondary light guide layer is a flat surface parallel to the lower surface of the reflector.

19. The light emitting package of claim 16, wherein an interface between the main light guide layer and the secondary light guide layer is a smooth curved surface.

20. The light emitting package of claim 16, further comprising a plurality of microstructures provided on an interface between the main light guide layer and the secondary light guide layer.
